(19) United States
(12) Patent Application Publication
(10) Pub. No.: US 2026/0037047 A1
(43) Pub. Date: Feb. 5, 2026

(54) SYSTEM LEVEL POWER MANAGEMENT VIA EXTERNALLY CONTROLLED MULTI-COMPUTE UNIT POWER LIMITING

(71) Applicant: QUALCOMM Incorporated, San Diego, CA (US)

(72) Inventors: Vijay Kiran KALYANAM, Austin, TX (US); Balakrishnan THIPIRAJAPURAMVENKATARAMAN, Austin, TX (US); Suresh Kumar VENKUMAHANTI, Austin, TX (US)

(21) Appl. No.: 18/789,587

(22) Filed: Jul. 30, 2024

(51) Int. Cl. G06F 1/28; G06F 1/3293

(52) U.S. Cl. CPC G06F 1/28; G06F 1/3293

(57) ABSTRACT

A method for system level power management for a system-on-chip (SoC) includes executing multiple compute units in the SoC. The method also includes receiving a digital power meter (DPM) value for each compute unit. The DPM value comprises an estimated power consumption of the compute unit. The method further includes modifying, in response to an updated system power budget, a fair power resource allocation for each of the multiple compute units of the SoC based on a respective DPM value and the updated system power budget. The modifying occurs without relying on a maximum DPM value across threads or across processors.

### BACKGROUND

### Field

Aspects of the present disclosure relate to compute devices, such as processor and processing threads, and more specifically to system level power management via externally controlled multi-compute unit power limiting.

### Background

Mobile or portable computing devices include mobile phones, laptop, palmtop and tablet computers, portable digital assistants (PDAs), portable game consoles, and other portable electronic devices. Mobile computing devices are comprised of many electrical components that consume power and generate heat. The components (or compute devices) may include system-on-chip (SoC) devices, graphics processing unit (GPU) devices, neural processing unit (NPU) devices, digital signal processors (DSPs), and modems, among others. It would be desirable to improve thermal and power management in the SoC devices.

### SUMMARY

In aspects of the present disclosure, a method for system level power management for a system-on-chip (SoC) includes executing multiple compute units in the SoC. The method also includes receiving a digital power meter (DPM) value for each compute unit. The DPM value comprises an estimated power consumption of the compute unit. The method further includes modifying, in response to an updated system power budget, a fair power resource allocation for each of the multiple compute units of the SoC based on a respective DPM value and the updated system power budget. The modifying occurs without relying on a maximum DPM value across compute units.

Other aspects of the present disclosure are directed to an apparatus. The apparatus has a memory and one or more processors coupled to the memory. The processor(s) is configured to execute multiple compute units in the SoC. The processor(s) is also configured to receive a digital power meter (DPM) value for each compute unit. The DPM value comprises an estimated power consumption of the compute unit. The processor(s) is further configured to modify, in response to an updated system power budget, a fair power resource allocation for each of the multiple compute units of the SoC based on a respective DPM value and the updated system power budget. The modifying occurs without relying on a maximum DPM value across compute units.

In other aspects of the present disclosure, a non-transitory computer-readable medium with program code recorded thereon is disclosed. The program code is executed by a processor and includes program code to execute multiple compute units in the SoC. The program code also includes program code to receive a digital power meter (DPM) value for each compute unit. The DPM value comprises an estimated power consumption of the compute unit. The program code further includes program code to modify, in response to an updated system power budget, a fair power resource allocation for each of the multiple compute units of the SoC based on a respective DPM value and the updated system power budget. The modifying occurs without relying on a maximum DPM value across compute units.

This has outlined, rather broadly, the features and technical advantages of the present disclosure in order that the detailed description that follows may be better understood. Additional features and advantages of the present disclosure will be described below. It should be appreciated by those skilled in the art that this present disclosure may be readily utilized as a basis for modifying or designing other structures for carrying out the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 illustrates an example implementation of a host system-on-chip (SoC), including a system level power manager, in accordance with certain aspects of the present disclosure.

FIG. 2 is a block diagram illustrating a multi-threaded processor configured for system power management via externally controlled multi thread power limiting, in accordance with various aspects of the present disclosure.

FIG. 3 is a circuit diagram illustrating details of the per thread throttle controller of FIG. 2, in accordance with various aspects of the present disclosure.

FIG. 4 is a flow diagram illustrating an example power management process performed, for example, by a mobile device, in accordance with various aspects of the present disclosure.

FIG. 5 is a block diagram showing an exemplary wireless communications system in which a configuration of the present disclosure may be advantageously employed.

FIG. 6 is a block diagram illustrating a design workstation used for circuit, layout, and logic design of components, in accordance with various aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. It will be apparent, however, to those skilled in the art that these concepts may be practiced without these specific details. In some instances, well-known structures and components are shown in block diagram form in order to avoid obscuring such concepts.

As described, the use of the term “and/or” is intended to represent an “inclusive OR,” and the use of the term “or” is intended to represent an “exclusive OR.” As described, the term “exemplary” used throughout this description means “serving as an example, instance, or illustration,” and should not necessarily be construed as preferred or advantageous over other exemplary configurations. As described, the term “coupled” used throughout this description means “connected, whether directly or indirectly through intervening connections (e.g., a switch), electrical, mechanical, or otherwise,” and is not necessarily limited to physical connections. Additionally, the connections can be such that the objects are permanently connected or releasably connected. The connections can be through switches. As described, the term “proximate” used throughout this description means “adjacent, very near, next to, or close to.” As described, the term “on” used throughout this description means “directly on” in some configurations, and “indirectly on” in other configurations.

A high performance system-on-chip (SoC) may have multiple threads or processors, such as machine learning or artificial intelligence (ML/AI)) accelerators, a central processing unit (CPU), and a graphics processing unit (GPU). The SoC implements system level power management to fairly allocate power resources to the various threads or processors for meeting system level power limits and achieving a desired system performance. In other words, processors/threads that consume more resources are penalized more. Both threads and processors may be generically referred to as compute units throughout the present disclosure, such that executing multiple compute units is performed in the SoC. An SoC power manager may use system power management for controlling power limits for input to a buck converter, for controlling battery-current power, and for controlling thermal design power (TDP) limits.

Existing multi-thread power limiting solutions are, however, prone to system level power limit violations or thermal violations in response to a dynamically changing system power budget (e.g., an updated system power budget). The power and thermal violations result from an individual compute unit's dependence on the maximum DPM across threads or across processors. A thread limits management hardware (TLMH) implementation may be subject to these drawbacks. Existing global limiting solutions are prone to system level performance violations in response to the dynamically changing system power budget. The performance violations result from a lack of power information for each individual compute unit. A global limits management hardware (GLMH) implementation may suffer from these drawbacks.

According to aspects of the present disclosure, a system level limits threshold (e.g., system power budget) and individual compute unit limits are considered for power and performance control decisions. For example, power consumption estimates from each digital power meter (DPM) of a neural signal processor (NSP) may be considered to make appropriate power or performance controls decisions on a per-thread basis.

In some aspects, system power management via externally controlled multi thread power limiting implements an external master control that accounts for system level limits when performing multi-thread power limiting. That is, each thread (or processor) may be controlled based on its power level. In these aspects, high power threads may be subject to more control than low power threads, but the control is not reliant on the maximum DPM value across threads or across processors for the power control decisions. That is, high power threads violating system level limits will be subject to power control without relying on the maximum DPM value across threads or across processors.

In some aspects, per-thread DPM estimated power consumption values may be averaged using a low-pass filter. That is, multiple DPM values for each thread are averaged to create a per-thread average DPM value. Each average DPM value is then rounded to a same scale as the system level limits. For example, if the system level limits are eight bits, each average DPM value is scaled to eight bits to enable a comparison. Next, the rounded value is compared against the system level limits. Consequently, without any dependence on either a maximum thread power level or any existing adaptative shared limit, per-thread throttle control is generated in response to a violation of system level limits.

Particular aspects of the subject matter described in this disclosure can be implemented to realize one or more of the following potential advantages. In some examples, the described techniques of system level power management enable high performance system-on-chip (SoC) devices with multiple threads or processors (e.g., ML/AI accelerators, CPUs, and GPUs) to perform system level power management with fair allocation of power resources (e.g., power resource allocation), within system level power limits, while meeting system performance metrics. Similarly, improved thermal management is achieved.

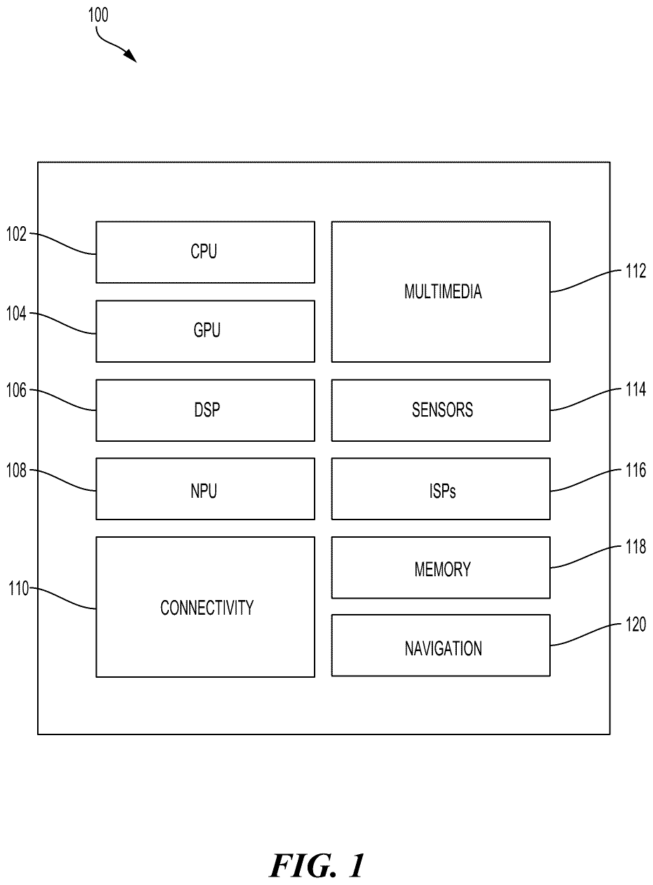

FIG. 1 illustrates an example implementation of a host system-on-chip (SoC) 100, which includes a system level power manager, in accordance with aspects of the present disclosure. The host SoC 100 includes processing blocks tailored to specific functions, such as a connectivity block 110. The connectivity block 110 may include fifth generation (5G) connectivity, fourth generation long term evolution (4G LTE) connectivity, Wi-Fi connectivity, universal serial bus (USB) connectivity, Bluetooth® connectivity, Secure Digital (SD) connectivity, and the like.

In this configuration, the host SoC 100 includes various processing units that support multi-threaded operation. For the configuration shown in FIG. 1, the host SoC 100 includes a multi-core central processing unit (CPU) 102, a graphics processor unit (GPU) 104, a digital signal processor (DSP) 106, and a neural processor unit (NPU) 108. The host SoC 100 may also include a sensor processor 114, image signal processors (ISPs) 116, a navigation module 120, which may include a global positioning system (GPS), and a memory 118. The multi-core CPU 102, the GPU 104, the DSP 106, the NPU 108, and the multi-media engine 112 support various functions such as video, audio, graphics, gaming, artificial networks, and the like. Each processor core of the multi-core CPU 102 may be a reduced instruction set computing (RISC) machine, an advanced RISC machine (ARM), a microprocessor, or some other type of processor. The NPU 108 may be based on an ARM instruction set.

According to aspects of the present disclosure, a mobile device includes a system level power manager. The system level power manager may include means for means for executing, means for receiving, means for modifying, means for filtering, means for rounding, and means for prioritizing. In one configuration, the means for means for executing, means for receiving, means for modifying, means for filtering, means for rounding, and means for prioritizing may be the CPU, GPU, DSP, NPU, ISPs, multimedia block and/or memory, as shown in FIG. 1. In other aspects, the aforementioned means may be any structure or any material configured to perform the functions recited by the aforementioned means.

A high performance system-on-chip (SoC), such as the host SoC 100, may have multiple threads or processors, such as machine learning or artificial intelligence (ML/AI)) accelerators (e.g., the NPU 108 of ML/AI threads), a central processing unit (CPU) (e.g., the CPU 102) and a graphics processing unit (GPU) (e.g., the GPU 104)). The SoC implements system level power management to fairly allocate power resources to the various threads or processors for meeting system level power limits and achieving desired system performance. Both threads and processors may be generically referred to as compute units throughout the present disclosure. An SoC power manager may use system power management for controlling power limits for input to a buck converter, for controlling battery-current power, and for controlling thermal design power (TDP) limits.

Existing multi-thread power limiting solutions are, however, prone to system level power limit violations or thermal violations in response to a dynamically changing system power budget. The power and thermal violations result from an individual compute unit's dependence on the associated power limits for the compute unit. A thread limits management hardware (TLMH) implementation may be subject to these drawbacks. Existing global limiting solutions are prone to system level performance violations in response to a dynamically changing system power budget. The performance violations result from a lack of power information for each individual compute unit. A global limits management hardware (GLMH) implementation may suffer from these drawbacks.

The NPU 108 (also referred to as an NSP (neural signal processor)) may include various processors and coprocessors where the processors may execute scalar instruction packets and issues vector instruction packets to the coprocessors. The NSP's limits management hardware (LMH) interfaces with a system power management (SPM) controller with look-up tables to compare thermal, current, or digital power meter (DPM) sensor outputs to programmable target thresholds for current, temperature, and system power/pre-buck limits.

The NSP integrates the limits management hardware (LMH) mechanisms such as the thread-LMH (TLMH) and a global-LMH (GLMH) for controlling the instruction-issue rates of coprocessor pipelines for meeting the limits specification.

In addition to issues with power management, existing solutions also have issues with thermal management. That is, thermal management should not be dependent on the maximum digital power meter (DPM) control. Thus, the same issues exist for both thermal and power limits.

According to aspects of the present disclosure, a system level limits threshold (e.g., system power budget) as well as individual compute unit limits are considered for power and performance control decisions. For example, power consumption estimates from each digital power meter (DPM) of a neural signal processor (NSP) may be considered to make appropriate power or performance controls decisions on a per-thread basis.

In some aspects, an system power management via externally controlled multi thread power limiting implements an external master control that accounts for system level limits when performing multi-thread power limiting. That is, each thread (or processor) may be controlled based on its power level. In these aspects, high power threads may be subject to more control than low power threads, but the control is not reliant on maximum DPM values across threads or across processors for the power control decisions. That is, high power threads violating system level limits are subject to power control without relying on the maximum DPM values across threads or across processors.

In some aspects, per-thread DPM estimated power consumption values may be averaged using a low-pass filter. That is, multiple DPM values for each thread are averaged to create a per-thread average DPM value. Each average DPM value is then rounded to a same scale as the system level limits. For example, if the system level limits are eight bits, each average DPM value is scaled to eight bits to enable a comparison. Next, the rounded value is compared against the system level limits. Consequently, without any dependence on either a maximum thread power level or any existing adaptative shared limit, per-thread throttle control is generated in response to violation of system level limits.

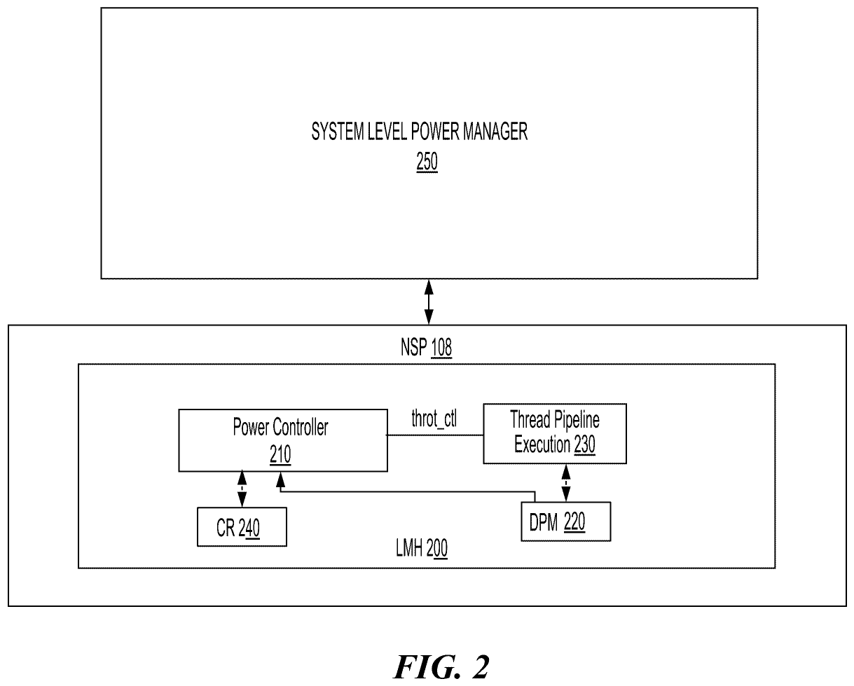

FIG. 2 is a block diagram illustrating a multi-threaded processor configured for system power management via externally controlled multi thread power limiting, in accordance with various aspects of the present disclosure. As previously noted, processing threads are an example of compute units and the present disclosure equally applies to multiple processors within an SoC.

As shown in FIG. 2, the NSP 108 includes a limits management hardware (LMH) system 200 configured for system level power control, in accordance with various aspects of the present disclosure. Although shown as implemented in the NSP 108, the LMH system 200 may be implemented in any of the processors (e.g., the multi-core CPU 102, the GPU 104, and/or the DSP 106) of the host SoC 100. Similarly, a system level power manager 250 may interface with the GPU 104, CPU 102 for a multi-compute implementation, which may include multiple hardware threads within the NSP 108.

In various aspects of the present disclosure, the NSP 108 receives a system power budget from a system level power manager 250. According to various aspects of the present disclosure, the LMH system 200 of the NSP 108 includes a per-thread unit power controller 210 configured to generate per-thread unit power control signal (throt_ctl) to control power for the NSP 108. According to various aspects of the present disclosure, the power controller 210 provides on-die power control. In this example, the power controller 210 utilizes configuration registers (CR) 240 to obtain system level limits as well as a digital power meter (DPM) 220 for providing estimates of power consumption of the threads operating in the thread pipeline execution block 230 of the NSP 108.

In this example, the NSP 108 is configured for multithreaded execution of multiple processor threads. In operation, power consumption of each processor thread executing in the thread pipeline execution block 230 is monitored to determine whether power control is needed. In various aspects of the present disclosure, the power controller 210 performs multi-thread power limiting based on system level limits obtained from the system level power manager 250 and the thread power consumption estimates obtained from the DPM 220.

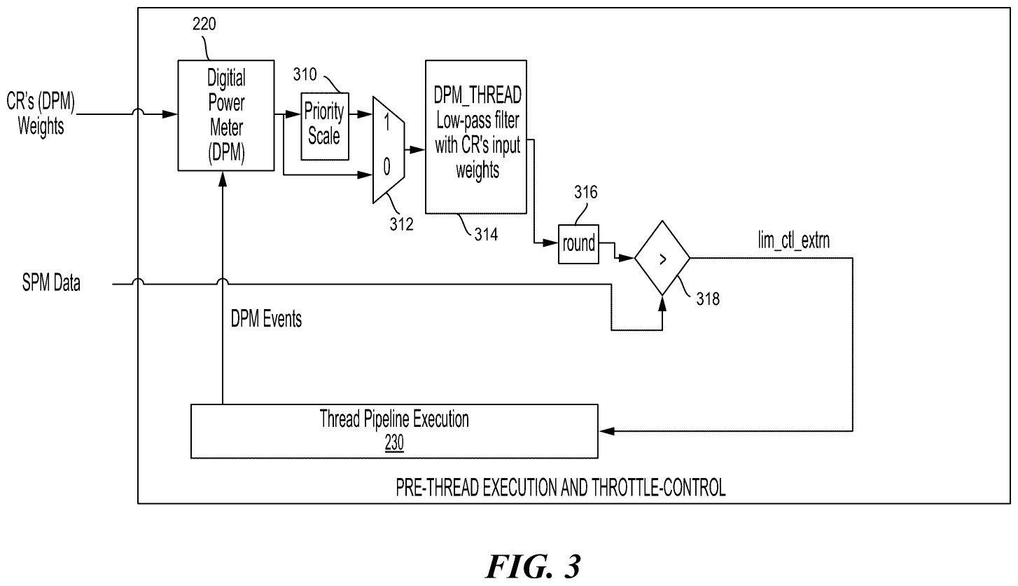

FIG. 3 is a circuit diagram illustrating details of the per-thread throttle controller of FIG. 2, in accordance with various aspects of the present disclosure. In the example of FIG. 3, digital power meter (DPM) weights stored in a control register are received at the digital power meter (DPM) 220. DPM weights have values of power weights of various events used in the DPM. DPM weights may be a simple sum of dot product of weights and events to produce a digital code every clock cycle. The DPM 220 estimates power consumption based on the weights and the threads (DPM events) running in the thread pipeline execution block 230. Each of the operations described with respect to FIG. 3 is performed for each thread (or compute unit).

A priority scaler 310 may receive thread priorities based on prioritizing selected compute units (e.g., thread priorities). Based on the priorities, output from the DPM 220 may be scaled. For example, a 10 watt output may be scaled to a one watt output if a thread has a high priority. Thus, the high priority thread is less likely to be subjected to power control. A multiplexor 312 may then select either the prioritized DPM value or the actual DPM value based on whether software wants to scale the DPM 220 based on thread priority or not. Accordingly, a CR signal (not shown) may operate as a floating input to control the multiplexor 312 to be ON or OFF.

Output of the multiplexor 312 is received at a filter 314, which is a low-pass filter in the example shown in FIG. 3. The filter 314 averages the DPM data to obtain the average estimated power consumption of each thread. The averaged DPM data is then rounded at a scaler 316 to be at the same scale as the system power limits data (SPM Data), for example, eight bits.

The SPM data, also referred to as system power limits, is compared at a comparator 318 with the rounded DPM data. A throttle control signal (e.g., lim_ctl_extn) is output from the comparator 318 based on a result of the comparison. When the average DPM of a thread exceeds the SPM data value, then the throttle signal will be asserted high eventually lowering the thread's power. Any thread with lower averaged DPM than the SPM data will be unaffected. The throttle control signal is received at the thread pipeline execution block 230 to control the power allocated to the thread. Similarly, in another implementation the sum of power of all threads can be compared against the SPM data (both of same scale) and when the sum exceeds the value, an adaptive shared limit can be adjusted such that the per-thread DPM values are now compared against the internal adaptive shared limit to obtain similar functionality without relying on the maximum DPM across the threads or across processors.

With external master control, the TLMH operates as a slave to the external master control from the SPM. In this mode, the TLMH is not dependent on a maximum DPM across threads or across compute resources comprising the multi-threaded processor and is controlled by the individual thread power and system level limits. In this mode, the DPM low-pass filter 314 receives data with or without thread-priority driving the signal to be rounded, (e.g., to eight-bit scale). The rounded value drives the throttle control signal, lim_ctl_extn, high when the rounded value is greater than the system level limits (SPM Data). With external master control, as system level limits change from 0 to 255, whenever the rounded value is greater than the system level limits, the throttle control signal, lim_ctl_extm, is asserted and performance starts decreasing. At a different thread power and for a specific system level limit, the TLMH reduces the performance of high power threads more than low power threads. The DPM values indicate whether a thread is a high power thread or a low power thread.

Thus, it can be seen that the system level limits are used as a threshold in combination with information of the averaged per-thread DPM. This combination inherently eliminates limits control-based low frequency resonant oscillations, which may occur with existing TLMH solutions. The system level power limit is used directly for better system level power control and better performance due to the usage of the DPM in combination with the system level limits. In scenarios where the absolute system level power violation is constant but the system level power limit changes, the external master control maintains the system to be within power limits.

Thus, aspects of the present disclosure facilitate system level power management. Similarly, thermal management violations with external control helps control throttle based on an NSP's per-thread DPM directly along with thermal power limits.

Aspects of the present disclosure enable high performance system-on-chip (SoC) devices with multiple threads or processors (e.g., ML/AI accelerators, CPUs, and GPUs) to perform system level power management with fair allocation of power resources to be within system level power limits while meeting system performance metrics. Similarly, improved thermal management is achieved.

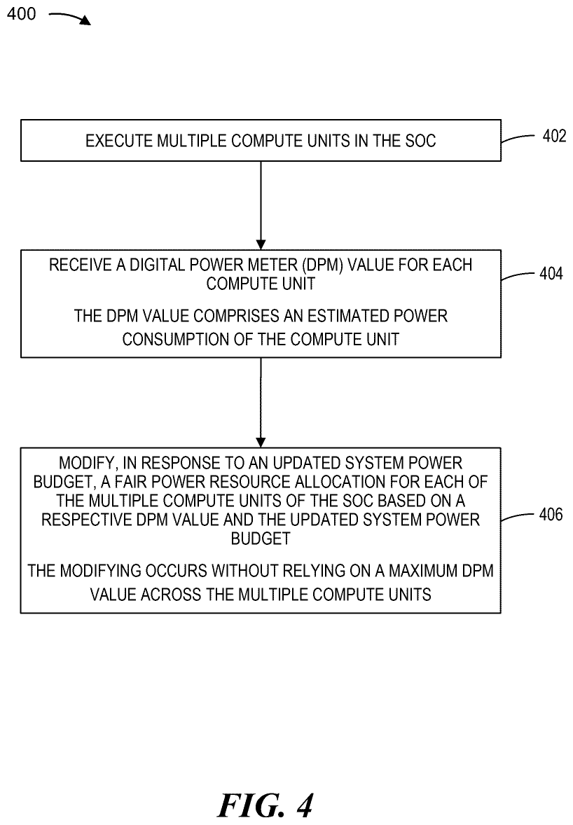

FIG. 4 is a flow diagram illustrating an example of a system level power management process 400 performed, for example, by a mobile device, in accordance with various aspects of the present disclosure. The example process 400 is an example of system level power management via externally controlled multi-compute unit power limiting.

As shown in FIG. 4, in some aspects, the process 400 may include executing multiple compute units in the SoC (block 402). For example, multiple threads of an NPU may execute.

In some aspects, the process 400 may include receiving a digital power meter (DPM) value for each compute unit. The DPM value comprising an estimated power consumption of the compute unit (block 404).

In some aspects, the process 400 may include modifying, in response to an updated system power budget, a fair power resource allocation for each of the multiple compute units of the SoC based on a respective DPM value and the updated system power budget. The modifying occurs without relying on a maximum DPM value across threads or across processors. (block 406). In some aspects, the process 400 may include modifying the fair power resource allocation by decreasing a power level for one of the multiple compute units in response to the respective DPM value being greater than the updated system power budget. In other aspects, the process 400 may modify a higher power compute unit before modifying a lower power compute unit.

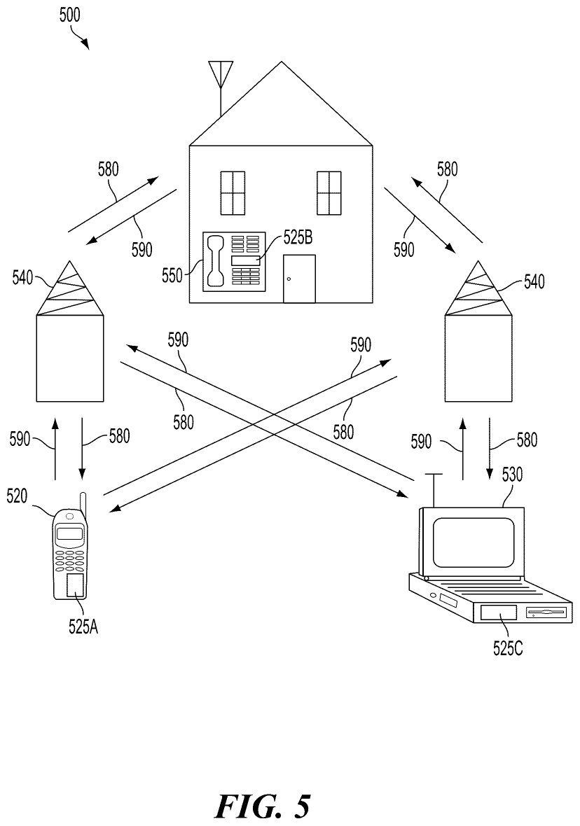

FIG. 5 is a block diagram showing an exemplary wireless communications system 500, in which an aspect of the present disclosure may be advantageously employed. For purposes of illustration, FIG. 5 shows three remote units 520, 530, and 550, and two base stations 540. It will be recognized that wireless communications systems may have many more remote units and base stations. Remote units 520, 530, and 550 include integrated circuit (IC) devices 525A, 525B, and 525C that include the disclosed power controller. It will be recognized that other devices may also include the disclosed power controller, such as the base stations, switching devices, and network equipment. FIG. 5 shows forward link signals 580 from the base stations 540 to the remote units 520, 530, and 550, and reverse link signals 590 from the remote units 520, 530, and 550 to the base stations 540.

In FIG. 5, remote unit 520 is shown as a mobile telephone, remote unit 530 is shown as a portable computer, and remote unit 550 is shown as a fixed location remote unit in a wireless local loop system. For example, the remote units may be a mobile phone, a hand-held personal communication systems (PCS) unit, a portable data unit, such as a personal data assistant, a GPS enabled device, a navigation device, a set top box, a music player, a video player, an entertainment unit, a fixed location data unit, such as meter reading equipment, or other device that stores or retrieves data or computer instructions, or combinations thereof. Although FIG. 5 illustrates remote units according to the aspects of the present disclosure, the disclosure is not limited to these exemplary illustrated units. Aspects of the present disclosure may be suitably employed in many devices, which include the disclosed power controller.

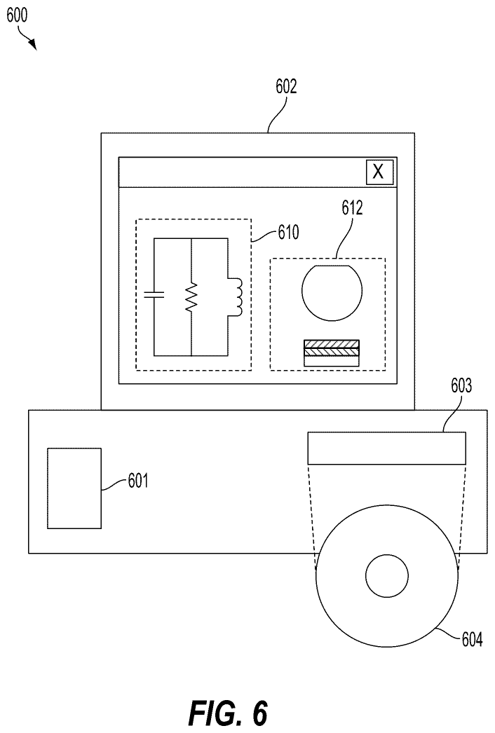

FIG. 6 is a block diagram illustrating a design workstation 600 used for circuit, layout, and logic design of a semiconductor component, such as the power controller disclosed above. The design workstation 600 includes a hard disk 601 containing operating system software, support files, and design software such as Cadence or OrCAD. The design workstation 600 also includes a display 602 to facilitate design of a circuit 610 or a semiconductor component 612, such as the power controller. A storage medium 604 is provided for tangibly storing the design of the circuit 610 or the semiconductor component 612 (e.g., the PLD). The design of the circuit 610 or the semiconductor component 612 may be stored on the storage medium 604 in a file format such as GDSII or GERBER. The storage medium 604 may be a CD-ROM, DVD, hard disk, flash memory, or other appropriate device. Furthermore, the design workstation 600 includes a drive apparatus 603 for accepting input from or writing output to the storage medium 604.

Data recorded on the storage medium 604 may specify logic circuit configurations, pattern data for photolithography masks, or mask pattern data for serial write tools such as electron beam lithography. The data may further include logic verification data such as timing diagrams or net circuits associated with logic simulations. Providing data on the storage medium 604 facilitates the design of the circuit 610 or the semiconductor component 612 by decreasing the number of processes for designing semiconductor wafers.

### EXAMPLE ASPECTS

Aspect 1: A method of system level power management for a system-on-chip (SoC), comprising: executing multiple compute units in the SoC; receiving a digital power meter (DPM) value for each compute unit, the DPM value comprising an estimated power consumption of the compute unit; and modifying, in response to an updated system power budget, a fair power resource allocation for each of the multiple compute units of the SoC based on a respective DPM value and the updated system power budget, the modifying occurring without relying on a maximum DPM value across compute units.
Aspect 2: The method of Aspect 1, further comprising filtering each DPM value to obtain an averaged per compute unit DPM value.
Aspect 3: The method of Aspect 2, in which the filtering comprises low-pass filtering.
Aspect 4: The method of any of the preceding Aspects, further comprising rounding each DPM value to a scale of the updated system power budget.
Aspect 5: The method of any of the preceding Aspects, in which modifying the fair power resource allocation comprises decreasing a power level for one of the multiple compute units in response to the respective DPM value being greater than the updated system power budget.
Aspect 6: The method of any of the preceding Aspects, further comprising modifying a higher power compute unit before modifying a lower power compute unit.
Aspect 7: The method of any of the preceding Aspects, further comprising prioritizing selected compute units, prior to modifying the fair power resource allocation.
Aspect 8: An apparatus for system level power management for a system-on-chip (SoC), comprising: at least one memory; and at least one processor coupled to the at least one memory, the at least one processor configured: to execute multiple compute units in the SoC; to receive a digital power meter (DPM) value for each compute unit, the DPM value comprising an estimated power consumption of the compute unit; and to modify, in response to an updated system power budget, a fair power resource allocation for each of the multiple compute units of the SoC based on a respective DPM value and the updated system power budget, the modifying occurring without relying on a maximum DPM value across compute units.
Aspect 9: The apparatus Aspect 8, in which the at least one processor is further configured to filter each DPM value to obtain an averaged per compute unit DPM value.
Aspect 10: The apparatus of Aspect 9, in which the at least one processor is further configured to filter with low-pass filtering.
Aspect 11: The apparatus of any of the Aspects 8-10, in which the at least one processor is further configured to round each DPM value to a scale of the updated system power budget.
Aspect 12: The apparatus of any of the Aspects 8-11, in which the at least one processor is further configured to decrease a power level for one of the multiple compute units in response to the respective DPM value being greater than the updated system power budget.
Aspect 13: The apparatus of any of the Aspects 8-12, in which the at least one processor is further configured to modify a higher power compute unit before modifying a lower power compute unit.
Aspect 14: The apparatus of any of the Aspects 8-13, in which the at least one processor is further configured to prioritize selected compute units, prior to modifying the fair power resource allocation.
Aspect 15: A non-transitory computer-readable medium having program code recorded thereon, the program code executed by a processor and comprising: program code to execute multiple compute units in the SoC; program code to receive a digital power meter (DPM) value for each compute unit, the DPM value comprising an estimated power consumption of the compute unit; and program code to modify, in response to an updated system power budget, a fair power resource allocation for each of the multiple compute units of the SoC based on a respective DPM value and the updated system power budget, the modifying occurring without relying on a maximum DPM value across compute units.
Aspect 16: The non-transitory computer-readable medium of Aspect 15, in which the program code comprises program code to filter each DPM value to obtain an averaged per compute unit DPM value.
Aspect 17: The non-transitory computer-readable medium of Aspect 16, in which the program code to filter comprises program code to low-pass filtering.
Aspect 18: The non-transitory computer-readable medium of any of the Aspects 15-17, in which the program code further comprises program code to round each DPM value to a scale of the updated system power budget.
Aspect 19: The non-transitory computer-readable medium of any of the Aspects 15-18, in which the program code to modify the fair power resource allocation comprises program code to decrease a power level for one of the multiple compute units in response to the respective DPM value being greater than the updated system power budget.
Aspect 20: The non-transitory computer-readable medium of any of the Aspects 15-19, in which the program code further comprises program code to modify a higher power compute unit before modifying a lower power compute unit.

For a firmware and/or software implementation, the methodologies may be implemented with modules (e.g., procedures, functions, and so on) that perform the functions described. A machine-readable medium tangibly embodying instructions may be used in implementing the methodologies described. For example, software codes may be stored in a memory and executed by a processor unit. Memory may be implemented within the processor unit or external to the processor unit. As used, the term “memory” refers to types of long term, short term, volatile, nonvolatile, or other memory and is not limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include random access memory (RAM), read-only memory (ROM), electrically erasable read-only memory (EEPROM), compact disc read-only memory (CD-ROM) or other optical disk storage, magnetic disk storage or other magnetic storage devices, or other medium that can be used to store desired program code in the form of instructions or data structures and that can be accessed by a computer. Disk and disc, as used, include compact disc (CD), laser disc, optical disc, digital versatile disc (DVD), floppy disk, and Blu-ray® disc, where disks usually reproduce data magnetically, while discs reproduce data optically with lasers. Combinations of the above should also be included within the scope of computer-readable media.

In addition to storage on computer-readable medium, instructions and/or data may be provided as signals on transmission media included in a communications apparatus. For example, a communications apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions, and alterations can be made without departing from the technology of the disclosure as defined by the appended claims. For example, relational terms, such as “above” and “below” are used with respect to a substrate or electronic device. Of course, if the substrate or electronic device is inverted, above becomes below, and vice versa. Additionally, if oriented sideways, above and below may refer to sides of a substrate or electronic device. Moreover, the scope of the present disclosure is not intended to be limited to the particular configurations of the process, machine, manufacture, composition of matter, means, methods, and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding configurations described may be utilized according to the present disclosure. Accordingly, the appended claims are intended to include within their scope such processes, machines, manufacture, compositions of matter, means, methods, or steps.

Those of skill would further appreciate that the various illustrative logical blocks, modules, circuits, and algorithm steps described in connection with the present disclosure may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure may be implemented or performed with a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in RAM, flash memory, ROM, erasable programmable read-only memory (EPROM), EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the present disclosure is provided to enable any person skilled in the art to make or use the present disclosure. Various modifications to the disclosure will be readily apparent to those skilled in the art, and the generic principles defined may be applied to other variations without departing from the spirit or scope of the disclosure. Thus, the present disclosure is not intended to be limited to the examples and designs described, but is to be accorded the widest scope consistent with the principles and novel features disclosed.

What is claimed is:

1. A method of system level power management for a system-on-chip (SoC), comprising:
executing multiple compute units in the SoC;
receiving a digital power meter (DPM) value for each compute unit, the DPM value comprising an estimated power consumption of the compute unit; and
modifying, in response to an updated system power budget, a fair power resource allocation for each of the multiple compute units of the SoC based on a respective DPM value and the updated system power budget, the modifying occurring without relying on a maximum DPM value across compute units.

2. The method of claim 1, further comprising filtering each DPM value to obtain an averaged per compute unit DPM value.

3. The method of claim 2, in which the filtering comprises low-pass filtering.

4. The method of claim 1, further comprising rounding each DPM value to a scale of the updated system power budget.

5. The method of claim 1, in which modifying the fair power resource allocation comprises decreasing a power level for one of the multiple compute units in response to the respective DPM value being greater than the updated system power budget.

6. The method of claim 1, further comprising modifying a higher power compute unit before modifying a lower power compute unit.

7. The method of claim 1, further comprising prioritizing selected compute units, prior to modifying the power resource allocation.

8. An apparatus for system level power management for a system-on-chip (SoC), comprising:
at least one memory; and
at least one processor coupled to the at least one memory, the at least one processor configured:
to execute multiple compute units in the SoC;
to receive a digital power meter (DPM) value for each compute unit, the DPM value comprising an estimated power consumption of the compute unit; and
to modify, in response to an updated system power budget, a fair power resource allocation for each of the multiple compute units of the SoC based on a respective DPM value and the updated system power budget, the modifying occurring without relying on a maximum DPM value across compute units.

9. The apparatus claim 8, in which the at least one processor is further configured to filter each DPM value to obtain an averaged per compute unit DPM value.

10. The apparatus of claim 9, in which the at least one processor is further configured to filter with low-pass filtering.

11. The apparatus of claim 8, in which the at least one processor is further configured to round each DPM value to a scale of the updated system power budget.

12. The apparatus of claim 8, in which the at least one processor is further configured to decrease a power level for one of the multiple compute units in response to the respective DPM value being greater than the updated system power budget.

13. The apparatus of claim 8, in which the at least one processor is further configured to modify a higher power compute unit before modifying a lower power compute unit.

14. The apparatus of claim 8, in which the at least one processor is further configured to prioritize selected compute units, prior to modifying the fair power resource allocation.

15. A non-transitory computer-readable medium having program code recorded thereon, the program code executed by a processor in a system-on-chip (SoC) and comprising:
program code to execute multiple compute units in the SoC;
program code to receive a digital power meter (DPM) value for each compute unit, the DPM value comprising an estimated power consumption of the compute unit; and
program code to modify, in response to an updated system power budget, a fair power resource allocation for each of the multiple compute units of the SoC based on a respective DPM value and the updated system power budget, the modifying occurring without relying on a maximum DPM value across compute units.

16. The non-transitory computer-readable medium of claim 15, in which the program code comprises program code to filter each DPM value to obtain an averaged per compute unit DPM value.

17. The non-transitory computer-readable medium of claim 16, in which the program code to filter comprises program code to perform low-pass filtering.

18. The non-transitory computer-readable medium of claim 15, in which the program code further comprises program code to round each DPM value to a scale of the updated system power budget.

19. The non-transitory computer-readable medium of claim 15, in which the program code to modify the fair power resource allocation comprises program code to decrease a power level for one of the multiple compute units in response to the respective DPM value being greater than the updated system power budget.

20. The non-transitory computer-readable medium of claim 15, in which the program code further comprises program code to modify a higher power compute unit before modifying a lower power compute unit.
